(19) United States
(12) Patent Application Publication
(10) Pub. No.: US 2021/0319802 A1
(43) Pub. Date: Oct. 14, 2021

(54) METHOD FOR PROCESSING SPEECH SIGNAL, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventor: Jinfeng BAI, Beijing (CN)

(73) Assignee: BEIJING BAIDU NETCOM SCIENCE AND TECHNOLOGY CO., LTD.

(21) Appl. No.: 17/342,078

(22) Filed: Jun. 8, 2021

(30) Foreign Application Priority Data
Oct. 12, 2020 (CN) 202011086047.6

(51) Int. Cl. G10L 21/0232; G10L 21/0332; G10L 25/30; G06N 3/08

(52) U.S. Cl. CPC G10L 21/0232; G06N 3/08; G10L 25/30; G10L 21/0332

(57) ABSTRACT

The disclosure provides a method for processing a speech signal, an electronic device and a storage medium. The method includes: obtaining a speech signal to be processed and a reference speech signal; obtaining a frequency-domain speech signal to be processed and a reference frequency-domain speech signal by respectively preprocessing the speech signal to be processed and the reference speech signal; obtaining a frequency-domain speech signal ratio by inputting the frequency-domain speech signal to be processed and the reference frequency-domain speech signal into a complex neural network model; and obtaining a target frequency-domain speech signal based on the frequency-domain speech signal ratio and the frequency-domain speech signal to be processed, and obtaining a target speech signal by processing the target frequency-domain speech signal.

### CROSS REFERENCE TO RELATED APPLICATION

This application is based on and claims priority to Chinese patent application No. 202011086047.6, filed on Oct. 12, 2020, the entire content of which is hereby introduced into this application as a reference.

### TECHNICAL FIELD

The disclosure relates to artificial intelligence technology fields such as speech technology and deep learning, and in particular to a method for processing a speech signal, an electronic device and a storage medium.

### BACKGROUND

Artificial intelligence is a subject to study simulating certain human thinking processes and intelligent behaviors (such as learning, reasoning, thinking and planning) by computers, which includes both hardware-level technologies and software-level technologies. Artificial intelligence technologies generally include technologies such as sensors, dedicated artificial intelligence chips, cloud computing, distributed storage and big data processing. Artificial intelligence software technologies include computer vision technologies, speech recognition technologies, natural language processing technologies, machine learning/deep learning, big data processing technologies, knowledge map technologies and other directions.

With rapid development of smart homes and mobile internet, devices based on speech interaction such as smart speakers, smart TVs and vehicle-mounted speech devices, are becoming popular and begin to enter people's daily lives. Therefore, it is required to recognize and process speech signals.

### SUMMARY

The embodiments of this disclosure provide a method for processing a speech signal, an electronic device and a storage medium.

Embodiments of the disclosure in a first aspect provide a method for processing a speech signal. The method includes: obtaining a speech signal to be processed and a reference speech signal; obtaining a frequency-domain speech signal to be processed and a reference frequency-domain speech signal by respectively preprocessing the speech signal to be processed and the reference speech signal; obtaining a frequency-domain speech signal ratio by inputting the frequency-domain speech signal to be processed and the reference frequency-domain speech signal into a complex neural network model; and obtaining a target frequency-domain speech signal based on the frequency-domain speech signal ratio and the frequency-domain speech signal to be processed, and obtaining a target speech signal by processing the target frequency-domain speech signal.

Embodiments of the disclosure in a second aspect provide an electronic device. The electronic device includes: at least one processor and a memory communicatively coupled to the at least one processor. The memory stores instructions executable by the at least one processor. When the instructions are implemented by the at least one processor, the at least one processor is configured to: obtain a speech signal to be processed and a reference speech signal; obtain a frequency-domain speech signal to be processed and a reference frequency-domain speech signal by respectively preprocessing the speech signal to be processed and the reference speech signal; obtain a frequency-domain speech signal ratio by inputting the frequency-domain speech signal to be processed and the reference frequency-domain speech signal into a complex neural. network model; and obtain a target frequency-domain speech signal based on the frequency-domain speech signal ratio and the frequency-domain speech signal to be processed, and obtain a target speech signal by processing the target frequency-domain speech signal.

Embodiments of the disclosure in a third aspect provide a non-transitory computer-readable storage medium storing computer instructions thereon. The computer instructions are configured to cause the computer to implement the method for processing a speech signal, and the method comprises: obtaining a speech signal to be processed and a reference speech signal; obtaining a frequency-domain speech signal to be processed and a reference frequency-domain speech signal by respectively preprocessing the speech signal to be processed and the reference speech signal; obtaining a frequency-domain speech signal ratio by inputting the frequency-domain speech signal to he processed and the reference frequency-domain speech signal into a complex neural network model; and obtaining a target frequency-domain speech signal based on the frequency-domain speech signal ratio and the frequency-domain speech signal to be processed, and obtaining a target speech signal by processing the target frequency-domain speech signal.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of a method for processing a speech signal according to Embodiment 1 of the disclosure.

FIG. 2 is an exemplary diagram of a speech signal according to embodiments of the disclosure.

FIG. 3 is an exemplary diagram of a speech signal according to embodiments of the disclosure.

FIG. 4a illustrates a frequency-domain speech signal to be processed.

FIG. 4b illustrates the target frequency-domain speech signal obtained according to the frequency-domain speech signal ratio and the frequency-domain speech signal to be processed.

FIG. 5 is a flowchart of a method for processing a speech signal according to Embodiment 2 of the disclosure.

FIG. 6 is an exemplary diagram of a scene for acquiring a speech signal sample according to embodiments of the disclosure.

FIG, 7 is a schematic diagram of a scene of a method for processing a speech signal according to Embodiment 3 of the disclosure.

FIG. 8 is a schematic diagram of a scene of a method for processing a speech signal according to Embodiment 3 of the disclosure.

FIG. 9 is a schematic diagram of a scene of a method for processing a speech signal according to Embodiment 3 of the disclosure.

FIG. 10 is a schematic diagram of an apparatus for processing a speech signal according to Embodiment 4 of the disclosure.

FIG. 11 is a schematic diagram of an apparatus for processing a speech signal according to Embodiment 5 of the disclosure.

FIG. 12 is a schematic diagram of an apparatus for processing a speech signal according to Embodiment 6 of the disclosure.

FIG. 13 is a block diagram of an electronic device used to implement the method for processing a speech signal according to embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

A method for processing a speech signal, an apparatus for processing a speech signal, an electronic device and a storage medium of the embodiments of the disclosure are described according to the attached drawings.

In actual application scenarios, devices based on speech interaction, such as smart speakers, smart TVs and vehicle-mounted speech devices, recognize and process speech signals. Therefore, it is required to process speech signals collected by audio collection devices such as microphone arrays.

In the related art, the speech signals collected by the sound collection devices such as the microphone arrays are processed based on a front-end signal processing algorithm. But, for the above method, with continuous update of the smart devices and remote recognition versions, update efficiency and effect of the above method for processing the speech signal are relatively poor, so that the effect of speech recognition is affected.

The disclosure provides a method for processing the speech signal. Before speech recognition is performed, a complex neural network model trained by a complex neural network is used to perform amplitude and phase processing on a collected speech signal to be processed and a reference speech signal simultaneously. In other words, by learning a relationship between an amplitude and a phase of a reference circuit and an amplitude and a phase of a sound collection device circuit such as an original microphone, a target speech signal to be recognized which is more accurate is obtained. Efficiency and effect of processing the speech signal are improved, so that accuracy of subsequent speech recognition is improved.

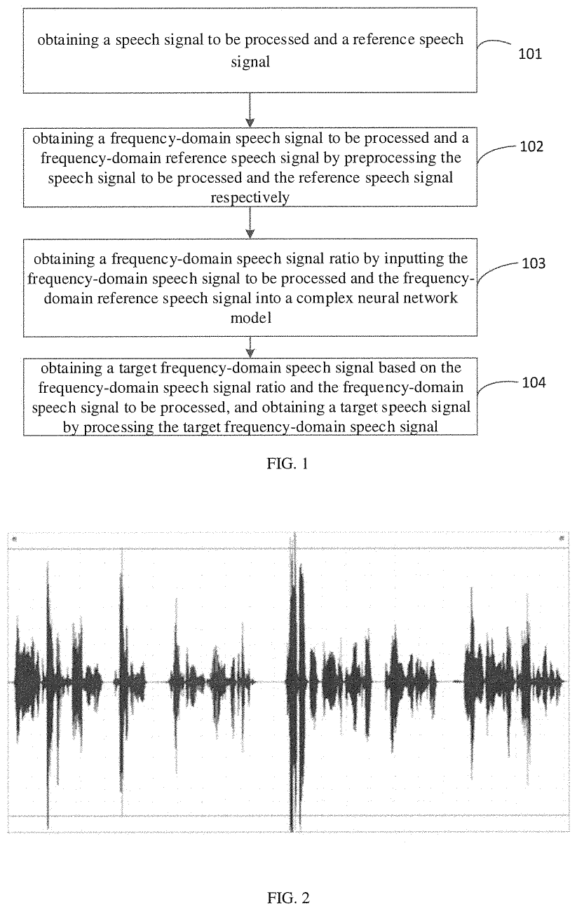

In detail, FIG. 1 is a flowchart of a method for processing a speech signal according to Embodiment 1 of the disclosure. As illustrated in FIG. 1, the method includes the following blocks.

At block 101, a speech signal to be processed and a reference speech signal are obtained.

In an embodiment, smart devices such as smart speakers and smart TVs all have audio collection devices, such as one or more microphone arrays, which may collect the speech signals to be processed.

It is understood that the smart devices may also include speakers, such as mono speakers, dual-channel speakers, or four-channel speakers. A speech signal generated by speakers may be a reference signal generated by a speaker circuit of the smart device. Therefore, the speech signal to be processed collected by the audio collection device include not only a target speech signal to be recognized and communicated, but also a reference signal played by the speaker and collected by the audio collection device. In order to improve the effect of speech recognition, the collected reference signal requires to be removed from the speech signal to be processed.

In an embodiment, each speech signal directly collected is a time-domain speech signal, such as a one-dimensional time-domain speech signal for each sampling point as illustrated in FIG. 2.

At block 102, a frequency-domain speech signal to be processed and a reference frequency-domain speech signal are obtained by respectively preprocessing the speech signal to be processed and the reference speech signal.

In an embodiment, after obtaining the speech signal to be processed and the reference speech signal, preprocessing is performed on the speech signal to be processed and the reference speech signal respectively, that is, the time-domain speech signal is framed and converted into a frequency-domain signal.

In an embodiment, there are many ways to preprocess the speech signal to be processed and the reference speech signal respectively, which are selected and set according to specific application scenarios. As a first example, fast Fourier transform may be performed on the speech signal to be processed and the reference speech signal respectively to obtain the frequency-domain speech signal to be processed and the reference frequency-domain speech signal. As a second example, the fast Fourier transform may be performed on the speech signal to be processed to obtain the frequency-domain speech signal to be processed, and wavelet transform may be performed on the reference speech signal. to obtain the reference frequency-domain speech signal. As a third example, wavelet transform may be performed on the speech signal to be processed to obtain the frequency-domain speech signal to be processed, and the reference speech signal is processed by function space decomposition formula to obtain the reference frequency-domain speech signal.

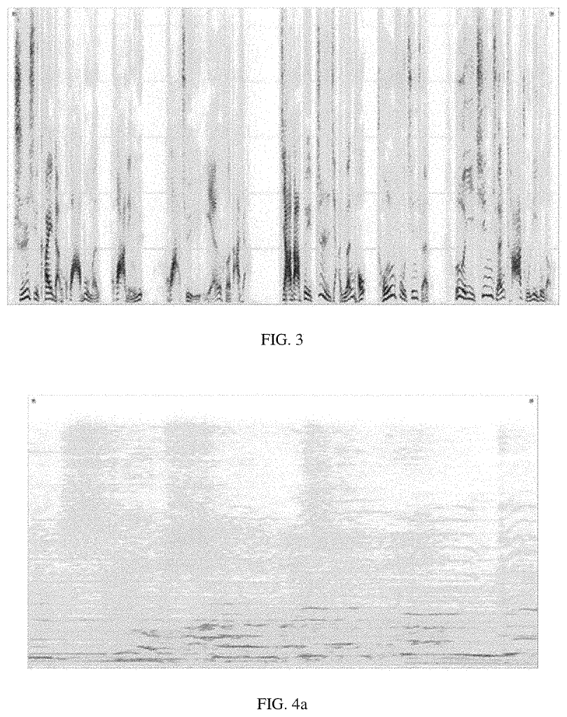

The frequency-domain speech signal to be processed and the reference frequency-domain speech signal are two-dimensional speech signals. For example, a horizontal dimension of the two-dimensional speech signals is a time dimension and a vertical dimension of the two-dimensional speech signals is a frequency dimension, that is, the two-dimensional speech signal may indicate the amplitude and phase of each frequency at different times, such as the two-dimensional speech signal illustrated in FIG. 3.

At block 103, a frequency-domain speech signal ratio is obtained by inputting the frequency-domain speech signal to be processed and the reference frequency-domain speech signal into a complex neural network model.

For example, the frequency-domain speech signal ratio may be configured to indicate a ratio relationship between a target speech signal in the speech signal to be processed and the speech signal to be processed.

In an embodiment, after obtaining the frequency-domain speech signal to be processed and the reference frequency-domain speech signal, the frequency-domain speech signal to be processed and the reference frequency-domain speech signal are input into the complex neural network model simultaneously. The complex neural network. model is pre-generated by training the complex neural network based on speech signal samples and ideal frequency-domain speech signal ratio. The input is the frequency-domain speech signal to be processed and the reference frequency-domain speech signal, and the output is the frequency-domain speech signal ratio.

The frequency-domain speech signal ratio may be understood as each frequency-band ratio coefficient of each frequency band at the same time point (namely, in each frame) after preprocessing. That is, the frequency-domain speech signal ratio may be an amplitude and phase ratio.

As a possible implementation, amplitudes and phases to be processed of respective frequencies at respective time points and reference amplitudes and reference phases of respective frequencies at respective time points are input into the complex neural network model, and amplitude and phase ratios of respective frequencies at respective time points, that is, at N consecutive time points are obtained. N is a positive integer, and a unit of the time point may be seconds.

The amplitude and phase ratio may be configured to indicate an amplitude and phase ratio relationship between the target speech signal and the speech signal to be processed.

It should he noted that for the amplitude and phase ratios of respective frequency bands at the same time, the amplitude and phase ratios of respective frequency bands at different time points is finally obtained. In addition, in order to improve the processing efficiency, the amplitude and phase ratio may be one or more of a complex ratio composed by amplitude and phase, a ratio composed by amplitude and amplitude, and a ratio composed by phase and phase.

At block 104, a target frequency-domain speech signal is obtained based on the frequency-domain speech signal ratio and the frequency-domain speech signal to be processed, and the target speech signal is obtained by processing the target frequency-domain speech signal.

In an embodiment, there are many ways to obtain the target frequency-domain speech signal according to the frequency-domain speech signal ratio and the frequency-domain speech signal to be processed. As a possible implementation, the target frequency-domain speech signal may be obtained by multiplying the frequency-domain speech signal to he processed of the same frequency at the same time point and the corresponding frequency-domain speech signal ratio.

For example, assuming that the reference speech signal from the speaker accounts for 80% in the speech signal to be processed, and the target speech signal to be recognized which is received from outside accounts for 20%, then the target speech signal is obtained by multiplying the received speech signal to be processed by 0.2. Respective frequency bands at respective time points correspond to different ratio coefficients, that is, the frequency-domain speech signal ratios, thus it is requires to process the frequency-domain speech signal to be processed in terms of one-to-one corresponding between times and frequencies.

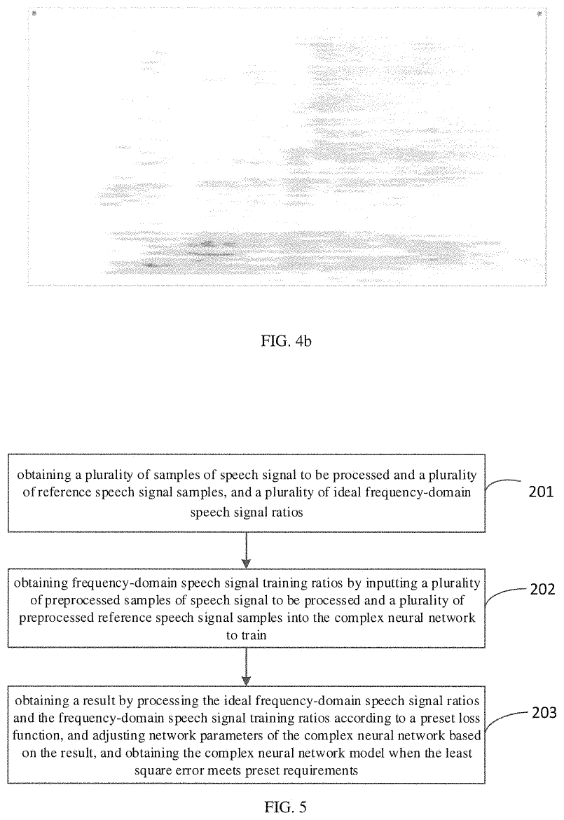

For example, as illustrated in FIGS. 4a-4b, FIG. 4a illustrates the frequency-domain speech signal to be processed, and FIG. 4b illustrates the target frequency-domain speech signal obtained according to the frequency-domain speech signal ratio and the frequency domain speech signal to be processed.

The target frequency-domain. speech signal is processed to obtain the target speech signal, that is, the frequency-domain speech signal is converted into the time-domain speech signal, and then the time-domain speech signal is subsequently input into a speech recognition model for speech recognizing. Thus, the accuracy of speech recognition is further improved.

According to the method for processing the speech signal of the embodiments of the disclosure, the speech signal to be processed and the reference speech signal are obtained. The frequency-domain speech signal to be processed and the reference frequency-domain speech signal are obtained by respectively preprocessing the speech signal to be processed and the reference speech signal. The frequency-domain speech signal ratio is obtained by inputting the frequency-domain speech signal to be processed and the reference frequency-domain speech signal into the complex neural network model. The target frequency-domain speech signal is obtained based on the frequency-domain speech signal ratio and the frequency-domain speech signal to be processed, and the target speech signal is obtained by processing the target frequency-domain speech signal. Therefore, the efficiency and effect of processing speech signal are improved and the accuracy of subsequent speech recognition is improved.

Based on description of the above embodiments, it is understood that the complex neural network model is pre-generated by training based on the speech signal samples and the complex neural network, which is specifically described in detail with reference to FIG. 5.

FIG. 5 is a flowchart of a method for processing a speech signal according to Embodiment 2 of the disclosure. As illustrated in FIG. 5, the method includes the following blocks.

At block 201, a plurality of samples of speech signal to be processed and a plurality of reference speech signal samples, and a plurality of ideal frequency-domain speech signal ratios are obtained.

The ideal frequency-domain speech signal ratio may be configured to indicate an ideal ratio relationship between the target speech signal and the frequency-domain speech signal to be processed.

In an embodiment of the disclosure, the speech signal samples are simulated and emulated. In detail, on the one hand, truly recorded and labeled data (or online collected and labeled data) may be used. On the other hand. simulated. data may be used. The simulation process includes two accepts, the first one is that near-field speech is simulated into a plurality of far-field speech to be processed, and the second one is that the plurality of far-field speech to be processed are simulated into a full-duplex speech with internal noise.

There are three ways to simulate the far-field speech form the near-field speech. The first way is to simulate base on a simulated impulse response function. The second way is to simulate based on an impulse response function truly recorded. The third way is to simulate by playing the near-field signal.

The simulation from the far-field speech to the full-duplex speech also includes three methods. The first method is to generate the full-duplex speech based on truly recorded data of operations of the device whose external is quiet. The second method is to generate the full-duplex speech by simulating based on the impulse response function recorded by the device. The third method is to obtain the full-duplex speech by recording near-field playing and operations of the device at the same time.

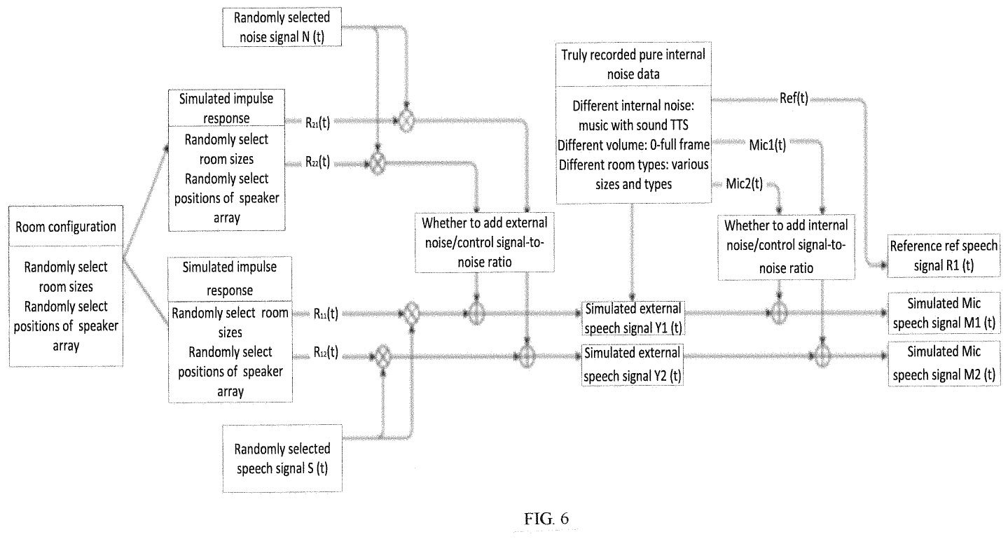

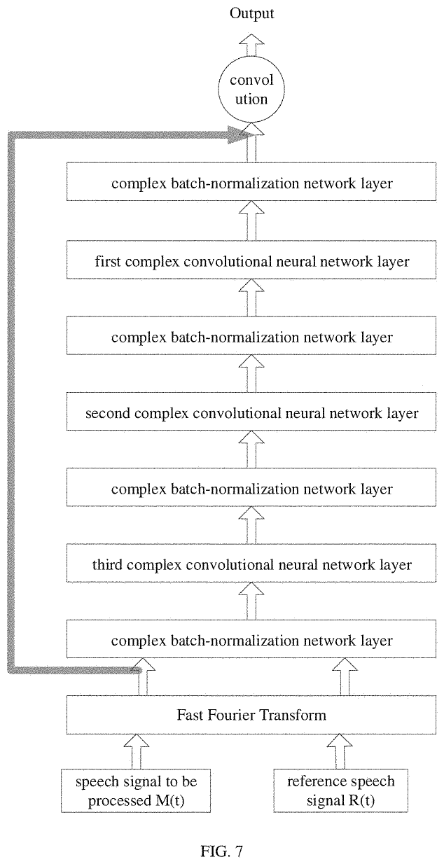

As a possible implementation, as illustrated in FIG. 6, simulation is performed for spatial areas of different sizes and audio collection devices (such as microphone arrays) at different positions, and a plurality of simulated impulse responses are obtained. Or, a plurality of true impulse responses may be record in real rooms, that is, a plurality of impulse responses are obtained. Randomly selected near-field noise signals and randomly selected near-field speech signals are respectively convolved with each of the plurality of impulse responses (including the simulated impulse responses and the true impulse responses) to obtain convolution results and the convolution results arc added according to a preset signal-to-noise ratio, thus each of a plurality of simulating external speech signals is obtained. The plurality of speech signals are collected from different audio devices (the external of each device requires to remain quiet when collection is performed) and added to the plurality of simulating external speech signals according to the preset signal-to-noise ratio, and the plurality of samples of speech signal to be processed are obtained. A plurality of speaker speech signals of different audio devices are obtained as the plurality of reference speech signal samples.

It is noted that FIG. 6 is only an example. The number of microphones and speakers are selected and set according to specific application scenarios. For example, there are only two microphones and one speaker, that is, there are two speech signals to be processed and one reference speech signal collected by a speaker circuit. In actual applications, there may be only one microphone, or three or more microphones. There may also be two or more speakers, which will be set according to specifically selections. Thus, availability and practicability of the model are improved.

It should be noted that, the plurality of samples of speech signal to be processed and the plurality of reference speech signal samples are simulated according to the plurality of corresponding ideal frequency-domain speech signal ratios.

At block 202, frequency-domain speech signal training ratios are obtained by inputting a plurality of preprocessed samples of speech signal to he processed and a plurality of preprocessed reference speech signal samples into the complex neural network to train.

In an embodiment, the complex neural network may include a complex convolutional neural network, complex batch normalization, complex full connection, complex activation, complex cyclic neural network including a complex Long Short-Term Memory (LSTM) artificial neural network, a complex Gated Recurrent Unit (GRU) network and a complex transformer.

In an embodiment, the complex neural network may operate in two categories in terms of the frequency dimension. One is independent processing for each frequency. There is no coupling between different frequencies, and the coupling relation only occurs between different time points of the same frequency. The other is mixed processing for frequencies, which includes one of coupling between adjacent frequencies and the other one of coupling between all frequencies.

In an embodiment, the complex neural network operates in two categories in terms of the time dimension. One is independent processing for each time point. The other is mixed processing for respective time points, which includes one of coupling of finite time point based on adjacent times and the other of coupling at all times.

As a possible implementation, samples of amplitude and phase to be processed of respective frequencies at respective time points and reference amplitude and phase samples of respective frequencies at respective time points are input into the complex neural network model to obtain the frequency-domain speech signal training ratio of respective frequencies at respective time points, that is, an amplitude and phase training ratio.

At block 203, a result is obtained by processing the ideal frequency-domain speech signal ratios and the frequency-domain speech signal training ratios according to a preset loss function, and network parameters of the complex neural network are adjusted based on the result, and the complex neural network model is obtained when the least square error meets preset requirements.

In an embodiment of the disclosure, for example, the ideal frequency-domain speech signal ratios and the frequency-domain speech signal training ratios are processed by a least square error loss function to obtain a least square error. The network parameters of each network of the complex neural network are adjusted according to the least square error until the least square error meets the preset requirements, for example, the frequency-domain speech signal training ratio obtained after processing by each network and the ideal frequency-domain speech signal ratio are the same or a difference between the frequency-domain speech signal training ratio and the ideal frequency-domain speech signal ratio is slight. And the complex neural network model is obtained.

Therefore, when the trained complex neural network model processes the speech signal, the “amplitude” and “phase” of the same frequency of the reference speech signal propagates through air and does not spread to other frequencies, that is, the amplitude and phase of the frequency are stable. There is a certain physical dependence between the “amplitude” and “phase” of the reference speech signal and the “amplitude” and “phase” of each of different speech signals to be processed. A specialized complex network is designed for learning, that is, complex full connection is adopted. The “amplitude” and “phase” of the reference speech signal and the “amplitude” and “phase” of each of different speech signals to be processed have a certain correlation over time. A specialized complex network is designed for learning, that is, the complex LSTM, the complex GRU, and the complex transformer are adopted. The relation between the “amplitude” and “phase” of the reference speech signal and the “amplitude” and “phase” of each of different speech signals to be processed has “translation invariance” on a relatively large scale, and a specialized complex network is designed for learning, that is, the complex cyclic convolutional network is adopted.

Based on description of the above embodiments, the complex neural network model of the disclosure may be as illustrated in FIG. 7, one or more identical or different complex neural network models may be trained. The plurality of speech signals to be processed and corresponding reference speech signals may be processed at the same time, or the speech signal to be processed may be divided into a plurality of sets of speech sub-signals to be processed according to frequency division rules or time sliding window, and the plurality of sets of speech sub-signals to be processed are processed respectively and then combined.

In detail as illustrated in FIG. 7, FIG. 7 is a schematic diagram of processing a reference signal and a signal to be processed. The speech signal to be processed M(t) and a reference speech signal R(t) are progressed by Fast Fourier Transform (FFT), and then input into complex neural network having a plurality of different layers(e.g., complex batch-normalization network layers in the Complex BN neural network, and different layers of convolutional neural network such as a first complex convolutional neural network layer (Complex f COV: 4@1X4), a second complex convolutional. neural network layer (Complex f COV: 2@1X4) and a third complex convolutional neural network layer (Complex f COV: 4@1X4)) to obtain the frequency-domain speech signal ratio. Then the target frequency-domain speech signal is obtained by multiplying the frequency-domain speech signal to be processed of the same frequency at the same time point by the corresponding frequency-domain speech signal ratio, and the target speech signal is obtained by processing the target frequency-domain speech signal and input into the speech recognition model.

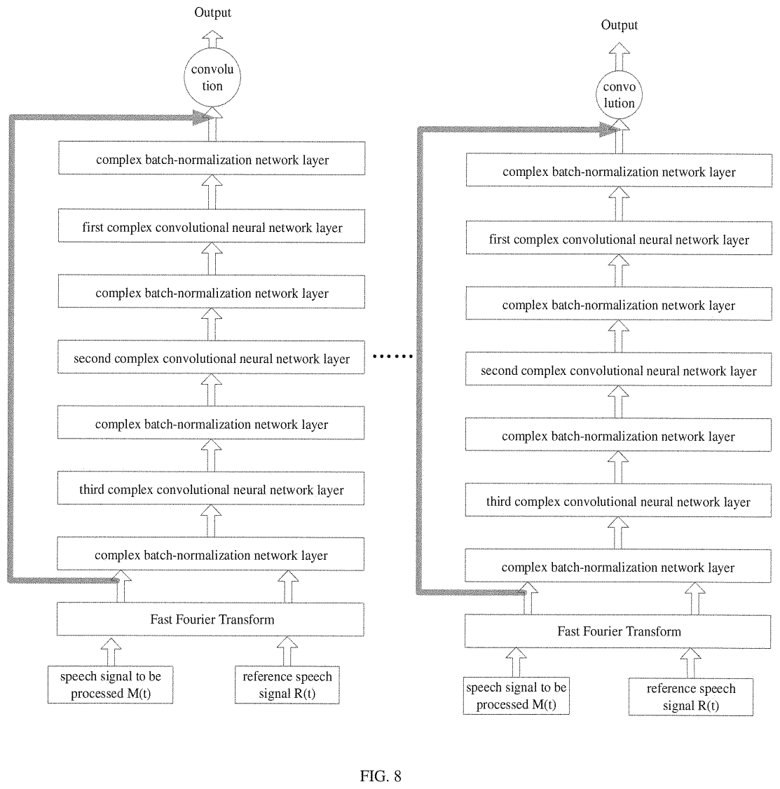

In detail, taking FIG. 8 as an example for description, FIG. 8 is a schematic diagram of processing the reference signal and the signal to be processed, the speech signals to be processed M(t) and the reference speech signals R(t) are progressed by FFT, and each speech signal to be processed M(t) and each reference speech signal R(t) are input into each complex neural network having a plurality of different layers (e.g., the complex batch-normalization network layer in the Complex BN neural network, and different layers of convolutional neural network such as Complex f COV: 4@1X4, Complex f COV: 2@1X4 and Complex f COV: 4@1X4) to obtain the frequency-domain speech signal ratio. Then the target frequency-domain speech signal is obtained by multiplying the frequency-domain speech signal to be processed of the same frequency at the same time point by the corresponding frequency-domain speech signal ratio, and the target speech signal is obtained by processing the target frequency-domain speech signal and input into the speech recognition model.

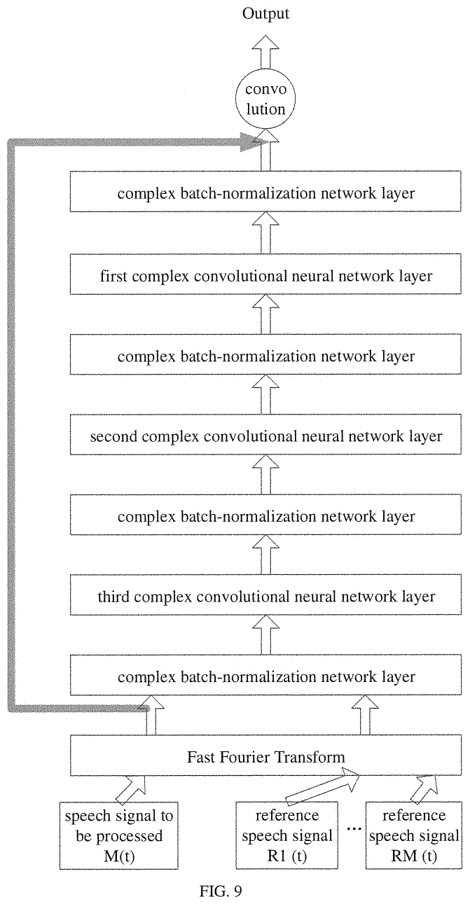

It is understandable that the number of reference signal inputs depends on the number of the speaker circuits, that is, there are as many reference signal inputs as there are speaker circuits. In detail, as illustrated in FIG. 9, the speech signal to he processed M(t) and the reference speech signals R1(t)-RM(t) are progressed by FFT and input into the complex neural network having a plurality of different layers (e.g., the complex hatch-normalization network layer in the Complex BN neural network, and different layers of convolutional neural network such as Complex f COV: 4@1X4. Complex f COV: 2@1X4 and Complex f COY: 4@1X4) to obtain the frequency-domain speech signal ratio. Then the target frequency-domain speech signal is obtained by multiplying the frequency-domain speech signal to be processed of the same frequency at the same time point by the corresponding frequency-domain speech signal ratio, and the target speech signal is obtained by processing the target frequency-domain speech signal and input into the speech recognition model. M is a positive integer greater than 1 and M(t) may be one or more, which will be selected according to scene settings.

It should be noted that FIGS. 7-9 are only examples. It may be processed by one by one reference signal and one by one signal to be processed, or it may also be processed by a plurality of signals to be processed and a plurality of reference signals together, or it may yet be processed by a plurality of reference signals and one signal to be processed, or it may yet be processed a plurality of reference signals and one signal to be processed by time sliding window and frequency division, which will be set based on specific application scenarios.

In an embodiment of the present disclosure, the frequency-domain speech signal may be the amplitude and phase of each frequency at each time point of a sentence (from a few seconds to tens of seconds), that is, the frequency-domain speech signal may be the amplitude and phase of each frequency at N consecutive time points. N is a positive integer greater than 1. The frequency-domain speech signal to be processed is divided according to the preset frequency division rules, and one sentence of frequency-domain speech signal is divided into a plurality of independent speech sub-signals to obtain a plurality of sets of amplitudes and phases to be processed. One sentence of frequency-domain speech signal is divided into a plurality of independent speech sub-signals, according to the preset frequency division rules, to obtain a plurality of sets of reference amplitudes and phases.

For example, 16bit quantized speech signal to be processed that samples with a 16k sampling rate is preprocessed and 256 frequencies are obtained after preprocessing and then the 256 frequencies are grouped. There may be grouped into four sets, i.e., a set of 0 to 63, a set of 64 to 127, a set of 128 to 191, and a set of 192 to 256, the sets are respectively input into the complex neural network model for processing.

In detail, the frequency-domain speech signal to be processed and the reference frequency-domain speech signal after preprocessing are divided into sets, and then sets obtained by dividing are respectively input into the complex neural network model, or input into different preset complex neural network models, and finally ratios related to the target speech is obtained. In addition, this division also includes the reference speech signal, and these signals together correspond to the sets.

In an embodiment of the present disclosure, the frequency-domain speech signal may be the amplitude and phase of each frequency at each time point of a sentence (from a few seconds to tens of seconds), that is, the frequency-domain speech signal may be the amplitude and phase of each frequency at N consecutive time points, N is a positive integer and greater than 1. One sentence of frequency-domain speech signal is divided into a plurality of independent time sub-segment speech signals through the time sliding window algorithm, that is, the sliding window division is performed according to the time to obtain a plurality of sets of amplitudes and phases to be processed. Through the time sliding window algorithm, the frequency-domain speech signal is divided into the plurality of independent time sub-segment speech signals, that is, sliding window division is performed according to the time, and the plurality of sets of reference amplitudes and phases are obtained. Since the target speech signal in the speech signal to be processed is related to the speech signal to be processed and the reference speech signal in a past period of time, but has nothing to do with the speech signals having a longer time.

It should be noted that dividing based on frequencies and dividing based on for processing, may either dividing based on frequencies or based on time windows, thus, the plurality of sets of amplitude and phase to be processed and the plurality of sets of reference amplitude and phase are obtained, thereby improving the effect of speech signal processing.

Further, the plurality of sets of amplitudes and phases to be processed, and the plurality of sets of reference amplitudes and phases are input into different complex neural network models to obtain first amplitude and phase ratios. The first amplitude and phase ratios are combined to obtain a second amplitude, and phase ratio. The plurality of sets of amplitudes and phases to be processed, and the plurality of sets of reference amplitudes and phases may be input into the same complex neural network model, but processing through different complex neural network models may improve the effect of speech signal processing.

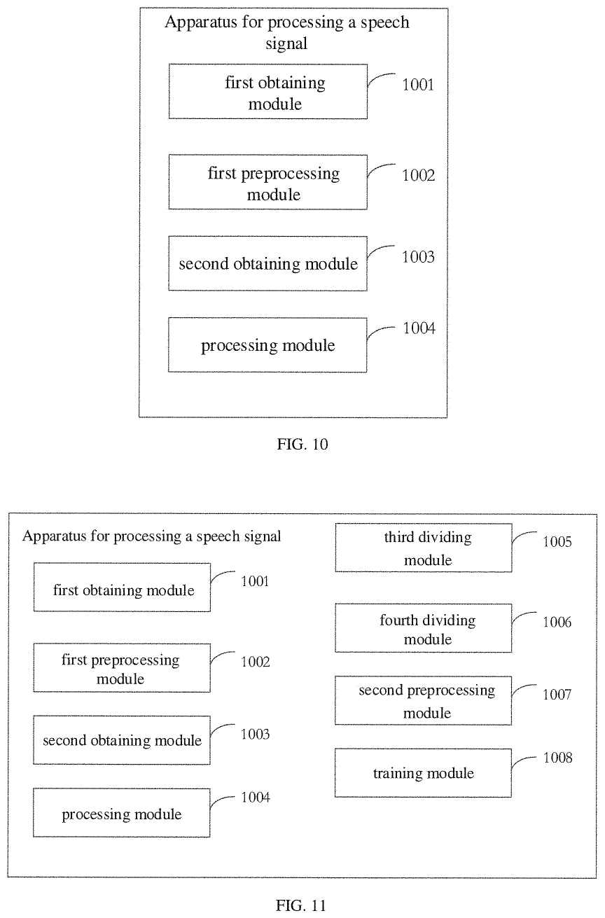

In order to implement the above embodiments, the disclosure provides an apparatus for processing a speech signal. FIG. 10 is a schematic diagram of an apparatus for processing a speech signal according to Embodiment 4 of the disclosure. As illustrated in FIG. 10, the apparatus includes: a first obtaining module 1001, a first preprocessing module 1002, and a second obtaining module 1003 and a processing module 1004.

The first obtaining module 1001 is configured to obtain a speech signal to be processed and a reference speech signal. The first preprocessing module 1002 is configured to obtain a frequency-domain speech signal to be processed and a reference frequency-domain speech signal by respectively preprocessing the speech signal to be processed and the reference speech signal. The second obtaining module 1003 is configured to obtain a frequency-domain speech signal ratio by inputting the frequency-domain speech signal to be processed and the reference frequency-domain speech signal into a complex neural network model. The processing module 1004 is configured to obtain a target frequency-domain speech signal based on the frequency-domain speech signal ratio and the frequency-domain speech signal to be processed, and obtain a target speech signal by processing the target frequency-domain speech signal.

It should be noted that the above explanation of the method for processing a speech signal is applicable to the apparatus for processing a speech signal of the embodiments of the disclosure, and the implementation principle is similar, which is not repeated here.

In conclusion, with the apparatus for processing a speech signal according to the embodiments of the disclosure, the speech signal to be processed collected by the array and the reference speech signal collected by the speaker circuit are obtained. The frequency-domain speech signal to be processed and the reference frequency-domain speech signal are obtained by respectively preprocessing the speech signal to be processed and the reference speech signal. The frequency-domain speech signal ratio is obtained by inputting the frequency-domain speech signal to be processed and the reference frequency-domain speech signal into the complex neural. network model. The target frequency-domain speech signal is obtained based on the frequency-domain speech signal ratio and the frequency-domain speech signal to be processed, and the target speech signal is obtained by processing the target frequency-domain speech signal. Therefore, the efficiency and effect of processing the speech signal are improved, so that the accuracy of subsequent speech recognition is improved.

In an embodiment, as illustrated in FIG. 10. the apparatus further includes: a third obtaining module 1005, a fourth obtaining module 1006, a second preprocessing module 1007 and a training module 1008. The third obtaining module 1005 is configured to obtain a plurality of samples of speech signal to be processed and a plurality of reference speech signal samples. The fourth obtaining module 1006 is configured to obtain a plurality of ideal frequency-domain speech signal ratios. The second preprocessing module 1007 is configured to obtain frequency-domain speech signal training ratios by inputting a plurality of preprocessed samples of speech signal to be processed and a plurality of preprocessed reference speech signal samples into the complex neural network to train. The training module 1008 is configured to obtain a result by processing the ideal frequency-domain speech signal ratios and the frequency-domain speech signal training ratios according to a preset loss function, and adjust network parameters of the complex neural network based on the result, and obtain the complex neural network model when the least square error meets preset requirements.

In an embodiment, the third obtaining module 1005 is configured to: obtain a plurality of impulse responses; select a near-field noise signal and a near-field speech signal randomly, and obtain each of a plurality of simulating external speech signals by convoluting the near-field noise signal and the near-field speech signal respectively with each impulse response to obtain convolution results and adding the convolution results; collect, a plurality of speech signals from different audio devices, and obtain the plurality of samples of speech signal to be processed by adding the plurality of speech signals from different audio devices to the plurality of simulating external speech signals according to the preset signal-to-noise ratio; and obtain a plurality of speaker speech signals of the audio devices as the plurality of reference speech signal samples.

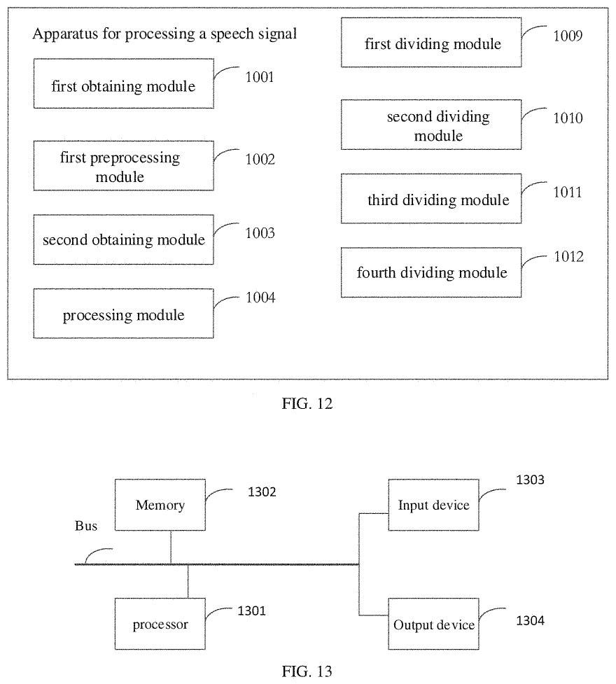

In an embodiment, the frequency-domain speech signal is the amplitude and phase of each frequency at each moment of one sentence (a few seconds to tens of seconds). As illustrated in FIG. 12, based on FIG. 10, the apparatus further includes: a first dividing module 1009, a second dividing module 1010, a third dividing module 1011 and a fourth dividing module 1012.

The first dividing module 1009 is configured to divide the frequency-domain speech signal to be processed according to preset frequency division rules, and obtain a plurality of sets of amplitudes and phases to be processed. The second dividing module 1010 is configured to divide the reference frequency-domain speech signal into a plurality of independent sub-speech signals according to the preset frequency division rules, and obtain a plurality of sets of reference amplitudes and phases. The third dividing module 1011 is configured to obtain a plurality of sets of amplitudes and phases to be processed by dividing the speech frequency-domain signal to be processed according to a time sliding window algorithm. The fourth dividing module 1012 is configured to obtain a plurality of sets of reference amplitudes and phases by dividing the reference frequency-domain speech signal according to the time sliding window algorithm.

In an embodiment, the second obtaining module 1003 is configured to: obtain a plurality of sets of first amplitude and phase ratios by inputting the plurality of sets of amplitudes and phases to be processed and the plurality of sets of reference amplitudes and phases respectively into the same complex neural network model or different complex neural network models; and obtain a second amplitude and phase ratio by combining the plurality of sets of first amplitude and phase ratios.

In an embodiment, the processing module 1004 is configured to: obtain the target frequency-domain speech signal by multiplying the frequency-domain speech signal to be processed to the corresponding frequency-domain speech signal ratio with the same frequency at the same time, and obtain the target speech signal by processing the target frequency-domain speech signal.

It should be noted that the above explanation of the method for processing a speech signal is applicable to the apparatus for processing a speech signal of the embodiments of the disclosure, and the implementation principle is similar, which is not repeated here. In conclusion, with the apparatus for processing a speech signal according to the embodiments of the disclosure, the speech signal to be processed and the reference speech signal are obtained. The frequency-domain speech signal to be processed and the reference frequency-domain speech signal are obtained by respectively preprocessing the speech signal to be processed and the reference speech signal. The frequency-domain speech signal ratio is obtained by inputting the frequency-domain speech signal to be processed and the reference frequency-domain speech signal into the complex neural network model. The target frequency-domain speech signal is obtained based on the frequency-domain speech signal ratio and the frequency-domain speech signal to be processed, and the target speech signal is obtained by processing the target frequency-domain speech signal. Therefore, the efficiency and effect of processing speech signal are improved, so that the accuracy of subsequent speech recognition is improved.

According to the embodiments of the disclosure, the embodiments of the disclosure provide an electronic device and a readable storage medium.

FIG. 13 is a block diagram of an electronic device used to implement a method for processing a speech signal according to embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 13, the electronic device includes: one or more processors 1301, a memory 1302, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 1301 is taken as an example in FIG. 13.

The memory 1302 is a non-transitory computer-readable storage medium according to the disclosure. The memory stores instructions executable by at least one processor, so that the at least one processor executes the method according to the disclosure. The non-transitory computer-readable storage medium of the disclosure stores computer instructions, which are used to cause a computer to execute the method according to the disclosure.

As a non-transitory computer-readable storage medium, the memory 1302 is configured to store non-transitory software programs, non-transitory computer executable programs and modules, such as program instructions/modules (for example, the first obtaining module 1001, the first preprocessing module 1002, the second obtaining module 1003 and the processing module 1004 shown in FIG. 8) corresponding to the method in the embodiments of the disclosure. The processor 1301 executes various functional applications and data processing of the electronic device by running non-transitory software programs, instructions, and modules stored in the memory 1302, that is, implementing the method in the foregoing method embodiments.

The memory 1302 may include a storage program area and a storage data area, where the storage program area may store an operating system and application programs required for at least one function. The storage data area may store data created according to the use of the electronic device for implementing the method. In addition, the memory 1302 may include a high-speed random access memory, and a non-transitory memory, such as at least one magnetic disk storage device, a flash memory device, or other non-transitory solid-state storage device. In some embodiments, the memory 1302 may optionally include a memory remotely disposed with respect to the processor 1301, and these remote memories may be connected to the electronic device for implementing the method through a network. Examples of the above network include, but are not limited to, the Internet, an intranet, a local area network, a mobile communication network, and combinations thereof.

The electronic device used to implement the method for processing a speech signal may further include: an input device 1303 and an output device 1304. The processor 1301, the memory 1302, the input device 1303, and the output device 1304 may be connected through a bus or in other manners. In FIG. 13, the connection through the bus is taken as an example.

The input device 1303 may receive inputted numeric or character information, and generate key signal inputs related to user settings and function control of an electronic device for implementing the method, such as a touch screen, a keypad, a mouse. a trackpad, a touchpad, an indication rod, one or more mouse buttons, trackballs, joysticks and other input devices. The output device 1304 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display, In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a. user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, sound input, or tactile input).

The systems and technologies described herein can be implemented in a computing system that includes background components (for example, a data server), or a computing system that includes middleware components (for example, an application server), or a computing system that includes front-end components (For example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area. network (LAN), wide area network (WAN), the Internet and block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and VPS services.

In the technical solution of the embodiments of the disclosure, the speech signal to be processed and the reference speech signal are obtained. The frequency-domain speech signal to be processed and the reference frequency-domain speech signal are obtained by respectively preprocessing the speech signal to be processed and the reference speech signal. The frequency-domain speech signal ratio is obtained by inputting the frequency-domain speech signal to be processed and the reference frequency-domain speech signal into the complex neural network model. The target frequency-domain speech signal is obtained based on the frequency-domain speech signal ratio and the frequency-domain speech signal to be processed, and the target speech signal is obtained by processing the target frequency-domain speech signal.

It should be understood that the various forms of processes shown above can be used to reorder, add or delete steps. For example, the steps described in the disclosure could be performed in parallel, sequentially, or in cl different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for processing a speech signal, comprising:
obtaining a speech signal to be processed and a reference speech signal;
obtaining a frequency-domain speech signal to be processed and a reference frequency-domain speech signal by respectively preprocessing the speech signal to be processed and the reference speech signal;
obtaining a frequency-domain speech signal ratio by inputting the frequency-domain speech signal to be processed and the reference frequency-domain speech signal into a complex neural network model; and
obtaining a target frequency-domain speech signal based on the frequency-domain speech signal ratio and the frequency-domain speech signal to be processed, and obtaining a target speech signal by processing the target frequency-domain speech signal.

2. The method according to claim 1, before inputting the frequency-domain speech signal to be processed and the reference frequency-domain speech signal into the complex neural network model, further comprising:
obtaining a plurality of samples of speech signal to be processed and a plurality of reference speech signal samples, and a plurality of ideal frequency-domain speech signal ratios;
obtaining frequency-domain speech signal training ratios by inputting a plurality of preprocessed samples of speech signal to be processed and a plurality of preprocessed reference speech signal samples into the complex neural network to train; and
obtaining a result by processing the ideal frequency-domain speech signal ratios and the frequency-domain speech signal training ratios according to a preset loss function, and adjusting network parameters of the complex neural network based on the result, and obtaining the complex neural network model when the least square error meets preset requirements.

3. The method according to claim 2, wherein obtaining the plurality of samples of speech signal to be processed and the plurality of reference speech signal samples comprises:
obtaining a plurality of impulse responses;
selecting a near-field noise signal and a near-field speech signal randomly, and obtaining each of a plurality of simulating external speech signals by convoluting the near-field noise signal and the near-field speech signal respectively with each impulse response to obtain convolution results and adding the convolution results based on a preset signal-to-noise ratio;
collecting a plurality of speech signals from different audio devices, and obtaining the plurality of samples of speech signal to be processed by adding the plurality of speech signals from different audio devices to the plurality of simulating external speech signals according to the preset signal-to-noise ratio; and
obtaining a plurality of speaker speech signals of the audio devices as the plurality of reference speech signal samples.

4. The method according to claim 1, wherein the frequency-domain speech signal is amplitudes and phases of respective frequencies at N consecutive time points, N is a positive integer greater than 1, and the method further comprises:
dividing the frequency-domain speech signal to be processed according to preset frequency division rules, and obtaining a plurality of sets of amplitudes and phases to be processed; and
dividing the reference frequency-domain speech signal into a plurality of independent sub-speech signals according to the preset frequency division rules, and obtaining a plurality of sets of reference amplitudes and phases.

5. The method according to claim 1, wherein the frequency-domain speech signal is amplitudes and phases of respective frequencies at N consecutive time points, and N is a positive integer greater than 1, and the method further comprises:
obtaining a plurality of sets of amplitudes and phases to be processed by dividing the speech frequency-domain signal to be processed according to a time sliding window algorithm; and
obtaining a plurality of sets of reference amplitudes and phases by dividing the reference frequency-domain speech signal according to the time sliding window algorithm.

6. The method according to claim 4, wherein obtaining the frequency-domain speech signal ratio by inputting the frequency-domain speech signal to be processed and the reference frequency-domain speech signal into the complex neural network model, comprises:
obtaining a plurality of sets of first amplitude and phase ratios by inputting the plurality of sets of amplitudes and phases to be processed and the plurality of sets of reference amplitudes and phases respectively into the same complex neural network model or different complex neural network models; and
obtaining a second amplitude and phase ratio by combining the plurality of sets of first amplitude and phase ratios.

7. The method according to claim 5, wherein obtaining the frequency-domain speech signal ratio by inputting the frequency-domain speech signal to be processed and the reference frequency-domain speech signal into the complex neural network model, comprises:
obtaining a plurality of sets of first amplitude and phase ratios by inputting the plurality of sets of amplitudes and phases to he processed and the plurality of sets of reference amplitudes and phases respectively into the same complex neural network model or different complex neural network models; and
obtaining a second amplitude and phase ratio by combining the plurality of sets of first amplitude and phase ratios.

8. The method according to claim 1, wherein obtaining the target frequency-domain speech signal based on the frequency-domain speech signal ratio and the frequency-domain speech signal to be processed, and obtaining the target speech signal by processing the target frequency-domain speech signal, comprises:
obtaining the target frequency-domain speech signal by multiplying the frequency-domain speech signal to be processed to the corresponding frequency-domain speech signal ratio with the same frequency, and obtaining the target speech signal by processing the target frequency-domain speech signal.

9. An electronic device, comprising:
at least one processor; and
a memory communicatively coupled to the at least one processor; wherein,
the memory stores instructions executable by the at least one processor, and when the instructions are implemented by the at least one processor, the at least one processor is configured to:
obtain a speech signal to be processed and a reference speech signal;
obtain a frequency-domain speech signal to be processed and a reference frequency-domain speech signal by respectively preprocessing the speech signal to be processed and the reference speech signal;
obtain a frequency-domain speech signal ratio by inputting the frequency-domain speech signal to be processed and the reference frequency-domain speech signal into a complex neural network model: and
obtain a target frequency-domain speech signal based on the frequency-domain speech signal ratio and the frequency-domain speech signal to be processed, and obtain a target speech signal by processing the target frequency-domain speech signal.

10. The electronic device according to claim 9, wherein the at least one processor is configured to:
obtain a plurality of samples of speech signal to be processed and a plurality of reference speech signal samples;
obtain a plurality of ideal frequency-domain speech signal ratios;
obtain frequency-domain speech signal training ratios by inputting a plurality of preprocessed samples of speech signal to be processed and a plurality of preprocessed reference speech signal samples into the complex neural network to train; and
obtain a result by processing the frequency-domain speech signal ideal ratios and the frequency-domain speech signal training ratios according to a preset loss function, and adjust network parameters of the complex neural network based on the result, and obtain the complex neural network model when the least square error meets preset requirements.

11. The electronic device according to claim 10, wherein the at least one processor is configured to:
obtain a plurality of impulse responses;
select a near-field noise signal and a near-field speech signal randomly, and obtain each of a plurality of simulating external speech signals by convoluting the near-field noise signal and the near-field speech signal respectively with each impulse response to obtain convolution results and adding the convolution results;
collect a plurality of speech signals from different audio devices, and obtain the plurality of samples of speech signal to be processed by adding the plurality of speech signals from different audio devices to the plurality of simulating external speech signals according to the preset signal-to-noise ratio; and
obtain a plurality of speaker speech signals of the audio devices as the plurality of reference speech signal samples.

12. The electronic device according to claim 9, wherein the frequency-domain speech signal is amplitudes and phases of respective frequencies at N consecutive time points, N is a positive integer greater than 1, and the at least one processor is configured to:
divide the frequency-domain speech signal to be processed according to preset frequency division rules, and obtain a plurality of sets of amplitudes and phases to be processed; and
divide the reference frequency-domain speech signal into a plurality of independent sub-speech signals according to the preset frequency division rules, and obtain a plurality of sets of reference amplitudes and phases;
or, wherein the at least one processor is configured to:
obtain a plurality of sets of amplitudes and phases to be processed by dividing the speech frequency-domain signal to be processed according to a time sliding window algorithm; and
obtain a plurality of sets of reference amplitudes and phases by dividing the reference frequency-domain speech signal according to the time sliding window algorithm.

13. The electronic device according to claim 12, wherein the at least one processor is configured to:
obtain a plurality of sets of first amplitude and phase ratios by inputting the plurality of sets of amplitudes and phases to he processed and the plurality of sets of reference amplitudes and phases respectively into the same complex neural network model or different complex neural network models; and
obtain a second amplitude and phase ratio by combining the plurality of sets of first amplitude and phase ratios.

14. The electronic device according to claim 9, wherein the at least one processor is configured to:
obtain the target frequency-domain speech signal by multiplying the frequency-domain speech signal to be processed to the corresponding frequency-domain speech signal ratio with the same frequency at the same time, and obtain the target speech signal by processing the target frequency-domain speech signal.

15. A non-transitory computer-readable storage medium storing computer instructions thereon, wherein the computer instructions are configured to cause the computer to implement a method for processing a speech signal, and the method comprises:
obtaining a speech signal to be processed and a reference speech signal;
obtaining a frequency-domain speech signal to be processed and a reference frequency-domain speech signal by respectively preprocessing the speech signal to be processed and the reference speech signal;
obtaining a frequency-domain speech signal ratio by inputting the frequency-domain speech signal to be processed and the reference frequency-domain speech signal into a complex neural network model; and
obtaining a target frequency-domain speech signal based on the frequency-domain speech signal ratio and the frequency-domain speech signal to be processed, and obtaining a target speech signal by processing the target frequency-domain speech signal.

16. The storage Medium according to claim 15, wherein, before inputting the frequency-domain speech signal to be processed and the reference frequency-domain speech signal into the complex neural network model, the method further comprises:
obtaining a plurality of samples of speech signal to be processed and a plurality of reference speech signal samples, and a plurality of ideal frequency-domain speech signal ratios;
obtaining frequency-domain speech signal training ratios by inputting a plurality of preprocessed samples of speech signal to be processed and a plurality of preprocessed reference speech signal samples into the complex neural network to train; and
obtaining a result by processing the ideal frequency-domain speech signal ratios and the frequency-domain speech signal training ratios according to a preset loss function, and adjusting network. parameters of the complex neural network based on the result, and obtaining the complex neural network model when the least square error meets preset requirements.

17. The storage medium according to claim 16. wherein obtaining the plurality of samples of speech signal to be processed and the plurality of reference speech signal samples comprises:
obtaining a plurality of impulse responses;
selecting a near-field noise signal and a near-field speech signal randomly, and obtaining each of a plurality of simulating external speech signals by convoluting the near-field noise signal and the near-field speech signal respectively with each impulse response to obtain convolution results and adding the convolution results based on a preset signal-to-noise ratio;
collecting a plurality of speech signals from different audio devices, and obtaining the plurality of samples of speech signal to be processed by adding the plurality of speech signals from different audio devices to the plurality of simulating external speech signals according to the preset signal-to-noise ratio; and
obtaining a plurality of speaker speech signals of the audio devices as the plurality of reference speech signal samples.

18. The storage medium according to claim 15, wherein the frequency-domain speech signal is amplitudes and phases of respective frequencies at N consecutive time points, N is a positive integer greater than 1, and the method further comprises:
dividing the frequency-domain speech signal to be processed according to preset frequency division rules, and obtaining a plurality of sets of amplitudes and phases to be processed; and
dividing the reference frequency-domain speech signal into a plurality of independent sub-speech signals according to the preset frequency division roles, and obtaining a plurality of sets of reference amplitudes and phases;
or, wherein, the method further comprises:
obtaining a plurality of sets of amplitudes and phases to be processed by dividing the speech frequency-domain signal to be processed according to a time sliding window algorithm; and
obtaining a plurality of sets of reference amplitudes and phases by dividing the reference frequency-domain speech signal according to the time sliding window algorithm.

19. The storage medium according to claim 17, wherein obtaining the frequency-domain speech signal ratio by inputting the frequency-domain speech signal to be processed and the reference frequency-domain speech signal into the complex neural network model, comprises;
obtaining a plurality of sets of first amplitude and phase ratios by inputting the plurality of sets of amplitudes and phases to be processed and the plurality of sets of reference amplitudes and phases respectively into the same complex neural network model or different complex neural network models; and
obtaining a second amplitude and phase ratio by combining the plurality of sets of first amplitude and phase ratios.

20. The storage medium according to claim 15, wherein obtaining the target frequency-domain speech signal based on the frequency-domain speech signal ratio and the frequency-domain speech signal to he processed, and obtaining the target speech signal by processing the target frequency-domain speech signal, comprises:
obtaining the target frequency-domain speech signal by multiplying the frequency-domain speech signal to be processed to the corresponding frequency-domain speech signal ratio with the same frequency, and obtaining the target speech signal by processing the target frequency-domain speech signal.
